(19) United States
(12) Patent Application Publication
(10) Pub. No.: US 2024/0411936 A1
(43) Pub. Date: Dec. 12, 2024

(54) RUNTIME SECURITY MONITORING OF HARDWARE

(71) Applicant: University of Florida Research Foundation, Incorporated, Gainesville, FL (US)

(72) Inventors: Mark M. Tehranipoor, Gainesville, FL (US); Hadi Mardani Kamali, Gainesville, FL (US); Farimah Farahmandi, Gainesville, FL (US); Kimia Zamiri Azar, Gainesville, FL (US); Tao Zhang, Gainesville, FL (US)

(21) Appl. No.: 18/664,736

(22) Filed: May 15, 2024

Related U.S. Application Data
(60) Provisional application No. 63/507,518, filed on Jun. 12, 2023.

(51) Int. Cl. G06F 21/76; G06F 11/07; G06F 21/75

(52) U.S. Cl. CPC G06F 21/76; G06F 11/076; G06F 21/755

(57) ABSTRACT

A system-in-package comprising one or more target chiplets comprising one or more applications, and a chiplet hardware security module (CHSM). The CHSM comprising a time-to-digital converter (TDC) sensor configured to generate one or more power traces associated with the one or more applications and a hardware security monitor configured to determine a presence of malicious attacks based on the one or more power traces.

### CROSS REFERENCE TO RELATED APPLICATION

This application claims the priority of U.S. Provisional Application No. 63/507,518, entitled “RUNTIME SECURITY MONITORING OF HARDWARE,” filed on Jun. 12, 2023, the disclosure of which is hereby incorporated by reference in its entirety.

### TECHNICAL FIELD

Various embodiments of the present disclosure relate to attack-induced anomaly detection, and more particularly to runtime fault injection attack detection in a system-in-package (SiP) environment.

### BACKGROUND

Heterogeneous integration-based system-in-package (SiP) circuits may provide performance density improvements to modem integrated circuits by integrating fabricated silicon dies into a unified package. That is, a combination of fabricated silicon dies, referred to as “chiplets,” may be combined in a SiP. However, due to inherent security concerns within the convoluted semiconductor supply chain and in-field environment, hostile attacks targeting software and hardware applications may present a formidable challenge to ensuring the security of SiP. That is, security threats such as software malware intrusion, hardware Trojan insertion, and fault injection attacks, present formidable challenges to the protection of on-chip assets. For example, SiP may introduce malicious chiplets to allow for internal and remote power fault injection attacks. Moreover, the immanent black-box nature of product chiplets and lack of golden models render most conventional security inspection and testing solutions less useful. Applicant has identified many technical challenges and difficulties associated with conventional inspection techniques and security mechanisms against software malware intrusions, hardware Trojan insertion, and fault injection attacks.

### BRIEF SUMMARY

Various embodiments described herein relate to methods, apparatuses, and systems for monitoring security of hardware. The disclosed embodiments may employ a time-to-digital converter (TDC) sensor to collect power profiles of targeted applications to create reference behaviors and train a machine learning engine of a hardware security module accordingly to determine deviations between actual runtime power fluctuations and expected runtime power fluctuations based on the reference behaviors. In some embodiments, a chiplet hardware security module is provided within a SiP to enable runtime system-level power noise variation monitoring capabilities and near-sensor machine learning inference for attack-induced anomaly detection.

In accordance with various embodiments of the present disclosure a system-in-package device is provided. In some embodiments, the system-in-package device comprises one or more target chiplets comprising one or more applications; and a chiplet hardware security module (CHSM), the CHSM comprising a time-to-digital converter (TDC) sensor configured to generate one or more power traces associated with the one or more applications; and a hardware security monitor configured to determine a presence of malicious attacks based on the one or more power traces.

In some embodiments, the TDC sensor is configured to generate the one or more power traces by digitizing power-varying propagation delay of buffer primitives that are associated with power side-channel switching activities by the one or more target chiplets. In some embodiments, the TDC sensor is further configured to generate reference power traces. In some embodiments, the hardware security monitor comprises a machine learning model trained based on the reference power traces. In some embodiments, the machine learning model is configured to determine whether runtime power traces associated with the one or more applications deviate from the reference power traces. In some embodiments, the hardware security monitor comprises an analog-to-digital converter (ADC) input configured to receive data samples from the TDC sensor; a first in, first out (FIFO) buffer configured to store the data samples from the ADC input; an interface module configured to load a window of data samples from the FIFO buffer into a machine learning inference engine; the machine learning inference engine (i) comprising the machine learning model and (ii) configured to predict a value of a next sample with respect to the window of data samples; an error calculator configured to determine a difference between the predicted value of the next sample with an actual value of the next sample from the FIFO buffer; and a deviation analyzer module configured to determine a presence of attack-induced anomalies based on the difference. In some embodiments, the deviation analyzer module is further configured to compare the difference with a threshold. In some embodiments, the deviation analyzer module is further configured to cache the difference to an error buffer; and determine an accumulated error value based on the cache difference. In some embodiments, the deviation analyzer module is further configured to compare the accumulated error value with an error value threshold; determine the accumulated error value exceeds the error value threshold; and increment an error amount counter based on the accumulated error value exceeding the error value threshold. In some embodiments, the deviation analyzer module is further configured to determine the error amount counter exceeds a number of errors threshold; and determine the presence of attack-induced anomalies based on the error amount counter exceeding the number of errors threshold.

In accordance with various embodiments of the present disclosure a computer-implemented method is provided. In some embodiments, the computer-implemented method comprises receiving, by one or more processors that are (i) communicatively coupled to one or more chiplets and (ii) comprised within a system-in-package (SiP) device that comprises the one or more chiplets, one or more power trace samples that are associated with the one or more chiplets; generating, by the one or more processors, one or more reference power traces based on the one or more power trace samples; initiating, by the one or more processors, training of a machine learning model based on the one or more reference power traces; and generating, by the one or more processors and using the machine learning model, one or more power anomaly predictions that are associated with the one or more chiplets.

In some embodiments, the one or more power trace samples are representative of power side-channel switching activities that are associated with one or more chiplets. In some embodiments, the computer-implemented method further comprises receiving the one or more power trace samples from a time-to-digital converter sensor that is configured on the SiP. In some embodiments, the one or more power trace samples comprise one or more power fluctuations on a power plane that is shared with the one or more chiplets. In some embodiments, the one or more reference power traces comprise one or more baseline power signatures of one or more hardware or software applications that are associated with the one or more chiplets. In some embodiments, the computer-implemented method further comprises monitoring one or more inference power traces of the one or more chiplets for one or more characteristics that are abnormal or consistent with one or more malicious attacks. In some embodiments, the computer-implemented method further comprises generating a quantization configuration based on one or more model parameters of the machine learning model; generating a high-level synthesis model based on the machine learning model and the quantization configuration; and generating a register-transfer level model based on the high-level synthesis model. In some embodiments, generating the one or more power anomaly predictions comprises determining one or more of (i) deviations from normal behavior, (ii) similarities to malicious attacks, or (iii) deviations between expected behaviors and actual behaviors. In some embodiments, the computer-implemented method further comprises determining one or more malicious activities based on the one or more power anomaly predictions. In some embodiments, the computer-implemented method further comprises initiating the performance of one or more prediction-based actions based on the determination of the one or more malicious activities.

### BRIEF DESCRIPTION OF THE DRAWINGS

Embodiments incorporating teachings of the present disclosure are shown and described with respect to the figures presented herein.

FIG. 1 illustrates a schematic diagram of an example architecture that may be used to practice embodiments of the present disclosure.

FIG. 2 illustrates an example system-in-package device in accordance with some embodiments discussed herein.

FIG. 3 illustrates an example cross-sectional view of an example system-in-package device in accordance with some embodiments discussed herein.

FIG. 4A, FIG. 4B, and FIG. 4C illustrate example system-in-package power distribution network configurations.

FIG. 5 illustrates an example schematic of a chiplet hardware security monitor in accordance with some embodiments discussed herein.

FIG. 6 illustrates an example schematic of a time-to-digital converter sensor in accordance with some embodiments discussed herein.

FIG. 7 illustrates an example schematic of a hardware security monitor in accordance with some embodiments discussed herein.

FIG. 8 is a flowchart diagram of an example process for providing runtime security of a hardware device in accordance with some embodiments of the present disclosure.

FIG. 9 is a flowchart diagram of an example process for application profiling in accordance with some embodiments of the present disclosure.

FIG. 10 depicts an example model parameter (weights and biases) profiling boxplot of a trained MLP machine learning model in accordance with some embodiments of the present disclosure.

FIG. 11 depicts a flowchart diagram of an example process for security monitoring in accordance with some embodiments of the present disclosure.

FIG. 12 depicts an operational example of a security monitoring architecture using power traces obtained from a TDC sensor.

FIG. 13 depicts an example error value threshold determination framework in accordance with some embodiments of the present disclosure.

FIG. 14 is an example algorithm for performing security monitoring in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

A long-time goal of electronics developers was to integrate a system with numerous functional circuits into a monolithic chip, which led to the development of System-on-Chips (SoC). However, Moore's law has reached saturation due to fabrication cost, power dissipation, and low yield at advanced technology node. Also, scalable hardware is necessary to perform complicated computations quickly and effectively for modern high-performance computing (HPC) and artificial intelligence-based technology. In order to go beyond Moore's Law, the development of heterogeneous integration (HI), which is based on modular deconstruction of SoCs, has been pushed by demands for more functionality, lower fabrication technology costs, higher yield, and scalability of hardware to be used for HPC.

A System-in-Packages (SiP) may be produced by heterogeneous integration of chiplets, fabricated on different technology nodes, on an interposer layer to perform like a traditional SoC. SiPs allow large designs to be disaggregated into smaller parts where these parts may comprise individual dies, referred to as “chiplets.” Despite the promising features, similar to their monolithic counterparts, HI-based devices, such as SiPs, also suffer from threatening hardware attack vectors such as side-channel attacks, fault injection attacks, and micro-probing attacks.

Side-channel adversaries may noninvasively break (e.g., cryptographic) implementations by exploiting the physical emissions from the running devices like power and electromagnetic (EM), regardless of the underlying mathematical strength whereas micro-probing may intrude the chips and directly access sensitive signals with the power of advanced equipment.

Instead of jeopardizing confidentiality, fault injection attacks focus more on integrity by physically inducing glitches to bypass built-in security mechanisms, assist algebraic fault analysis, or escalate privileges. Physical fault injection attacks may be performed in the manner of power, clock, EM, or laser glitches. The specific choice when faulting a microelectronic device may depend on the capabilities and requirements of adversaries regarding cost, expertise, accessibility of critical pins, and precision. For example, if an adversary can access the power supply pin of a device, the voltage level may be manipulated to inject power glitches. As such, the delay of internal components may increase and violate design timing constraints to result in faulty behaviors. Similarly, premature clocks may lead to setup/hold time violations.

Both power and clock fault injection are low-cost yet less precise because the impacts are usually global and affect all primitives. On the contrary, EM and laser disturbance may enable very spatially localized and accurate fault injection by inducing Eddy current in loop-shaped on-chip interconnects and forcing photons to jump from the valence band to the conduction band, respectively. The downsides of EM and laser fault injection are the relatively high price of required equipment and intensive expertise. Although physical fault injection attacks have drawn extensive traction from both academia and industry, few investigations have been done in terms of the feasibility and mitigation practices in the context of HI.

As a matter of fact, the complicated business model and supply chain of HI-based SiPs open doors to adversaries to inject faults in an even more flexible way. For example, an internal malicious phase-locked loop chiplet might intentionally create clock glitches to expect faulty outputs. Alternatively, malicious circuitry like power wasters may suddenly draw an excessive amount of current through a shared power distribution network (PDN) where the intrinsic impedance would lower the voltage drop to consequently generate power glitches. Owing to the black-box nature of individual chiplets and limitations of countermeasures, integration-time security inspection may hardly be able to identify malicious logic, and conventional in-field fault injection is difficult to predict.

Voltage glitching and clock glitching may be relatively easy and most inexpensive to perform. By manipulating the power supply with significant power variations or underpowering a device, voltage glitching may be performed by introducing fault in the logic circuits.

For clock glitching, devices using external clock generators may be compromised by sending incorrect clock signals with fewer or more pulses than required. However, the options for clock cycle modifications for the clock generator of the attacker become challenging as the operating frequency of the target device increases.

Another way to inject fault is by strong EM alterations near the device. While analog devices are vulnerable to harmonic EM waves, digital circuits, due to being clocked, need strongly controlled EM injection within a clock cycle. As EM impacts an entirety of a device, it may be essential to protect the other areas of a chip that are not being affected by faults.

Optical fault injection using camera flush, X-ray, UV-ray, laser etc., may be considered semi-invasive, and has the drawback of chip de-packaging for the attacks. Works have been done by using inexpensive camera flush to cause random faults, key extraction in Rivest-Shamir-Adleman (RSA) and Advanced Encryption Standard (AES) encryption, and costly X-ray attacks at the nanoscale level to pinpoint a single transistor. Moreover, memory components may be probed using laser fault injection (LFI). Additionally, focused ion beam (FIB) in optical fault injection may be the most powerful and effective for performing accurate fault injection used to reverse engineer the read bus of a memory containing cryptographic keys. As a whole, attacks in optical fault injection vary based on the motivation, capability, expense, and expertise of the attackers.

Making the device physically inaccessible to the attacker by using tamper-proof packaging technology is one method of offering countermeasures against fault injection. Other methods for fault injection attack detection involve using redundancy by using circuit duplication or majority voting, and error detection code (EDC). In addition, sensors may be employed to detect fault injection, including device-level sensors, glitch detection sensors for EM detection, and digital sensors for LFI detection. The creation of inherently fault-resistant algorithms, such as Critically-Aware Fault-Tolerance Enhancement Techniques (CRAFT), is another method for preventing fault injection attacks.

Furthermore, chiplets and silicon interposers may be sourced from third-party designers and foundries where malicious hardware Trojans may be inserted at an arbitrary stage during the production of SiPs via heterogeneous integration (HI). As an example, there are three main phases in a SiP supply chain, chiplet development, SiP integration, and in-field operations. Chiplet designers may rely on modern electronic design automation (EDA) solutions to translate high-level abstractions to layout designs which may be handed to third-party (offshore) facilities for wafer fabrication and testing. Also, chiplets may need to be interconnected with silicon infrastructure such as an interposer. In this stage, the chiplet/interposer designers may intentionally implant malicious functionality, e.g., power wasters, in their devices which may be activated even remotely during run-time to fault other chiplets in the same power region. Malicious circuitry may also be implanted by design-for-test or design-for-debug teams or unintentional EDA optimization. Such malevolent components may also be inserted by foundries during fabrication as they usually have access to all the design details. For instance, chiplets may be designed and fabricated by third-party entities where malicious hardware Trojans may be implanted stealthily to corrupt the original functionality.

SiP designers/integrators may break the holistic functionality of a SiP into modular pieces and look for appropriate chiplets and interposers through distribution channels. Like building blocks, third-party chiplets may be interconnected together and packaged into a unified package. Nevertheless, it may be assumed that involved entities of the integration phase may be trusted because, for example, SiP integrators are stakeholders of final products and serve as the owner of production systems and do not have the motivation to compromise them.

However, SiP integrators rely on chiplet design and fabrication capabilities from upstream entities, such as chiplet designers and offshore foundries, which allows for the potential implantation of malicious functionality in individual chiplets. Specifically, chiplet designers may implement hardware Trojans to intercept sensitive inter-chiplet communication after being integrated into a SiP, causing illegitimate physical impacts on the global on-chip infrastructure like the power distribution network to induce faults into other chiplets, and/or induce significant performance degradation by injecting a large volume of fake traffic in the on-chip communication infrastructure. Hardware Trojans may be silently inserted, for example, by altering lines of code in the original register-transfer level (RTL) implementation or adding gates in the netlist. Also, rogue foundries have access to GDSII files which allow them a chance to manipulate designs as they want or modify masks to inject Trojans. During ecosystem development, included third-party and untrusted distributors may intentionally stream malicious hardware chiplets to the supply chain as well.

The post-integration stage is when a SiP enters the user domain to serve a wide spectrum of mission-critical applications such as data centers and smartphones and operate in a field where software-level attacks become possible. End-users may tamper with the chiplet firmware for unauthorized jailbreak-like privilege escalation. Adversarial end-users may physically inject faults to steal/tamper with on-chip assets by bypassing the security checking or flipping critical configurations, for example. Also, remote network attackers may exploit vulnerabilities of public application programming interfaces (APIs) or operating systems to stealthily transfer and execute malware and ransomware on a SiP device to re-purpose the computing power of the device or hijack the device for ransom. Such malware may violate the control-flow integrity of the original applications and thus destroy the pattern of switching activities in the on-chip power network. Integrated chiplets, such as networked microprocessors may also be intruded on through cyber-attacks that alter the control flow of running applications.

Although countermeasures, such as hardware Trojan detection and software control-flow integrity (CFI) verification exist for conventional SoCs, the idiosyncrasies of SiP development and architecture present challenges to ensuring its security using the existing solutions. Traditional pre-silicon detection solutions may comprise performing security inspection over design files under whitebox assumptions. However, access to original design files by a SiP integrator is unlikely. Post-silicon logic testing may be used to detect malicious functionality of circuit hardware by feeding test patterns to the circuit hardware for Trojan activation and observation of erroneous outputs. However, in the case of SiPs, testing infrastructure, such as scan chains may be disabled by manufacturers after wafer-level tests, inhibiting post-silicon Trojan detection. Additionally, such test patterns may be derived by chiplet designers who may intentionally target a low detection coverage to conceal the Trojan regions.

Despite the existence of security monitoring solutions for malware detection for traditional SoC-based devices, malware detection techniques during runtime for SiPs are lacking. While runtime software application integrity verification solutions exist, they may be computationally taxing, bringing significant performance degradation. Despite efforts to reduce the overhead of runtime software application integrity verification solutions by leveraging hardware performance counters (HPCs) and machine learning algorithms, the effectiveness of such solutions remains questionable. Furthermore, existing software security applications (a) may be attacked and (b) use static analysis, which is unable to detect altered malware.

Given the aforementioned challenges, embodiments of the present disclosure provide hardware and software components for integrating SiPs with integrity verification functionality at runtime. In some embodiments, a security module comprising a power sensor is configured to monitor run-time activities through power noise variations on a PDN shared with one or more target chiplets installed on a SiP. As such, when hardware Trojans are activated or the control flow of running software applications is altered by malware intrusions, the security monitor may detect the resultant power anomalies and trigger corresponding policies.

The present disclosure provides systems and methods for security monitoring on hardware devices, such as SiPs, during runtime to non-invasively track application-level behaviors of target chiplets and detect any deviations potentially induced by underlying malicious intrusions. In some embodiments, a SiP is configured with an in-situ power sensor and a trained machine learning model on a field-programmable gate array (FPGA)-based chiplet hardware security module (CHSM) to perform runtime security monitoring functionality based on power noise variations. Power fluctuations of potential victim chiplets may be captured and analyzed in-field to detect attack-induced anomalies and trigger corresponding countermeasures. This technique will lead to more effective protection of hardware. In doing so, the techniques described herein improve the efficiency and speed of securing hardware, thus reducing the number of computational operations needed. Accordingly, the techniques described herein improve at least one of the computational efficiency, storage-wise efficiency, and speed of performing hardware protection.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example of programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

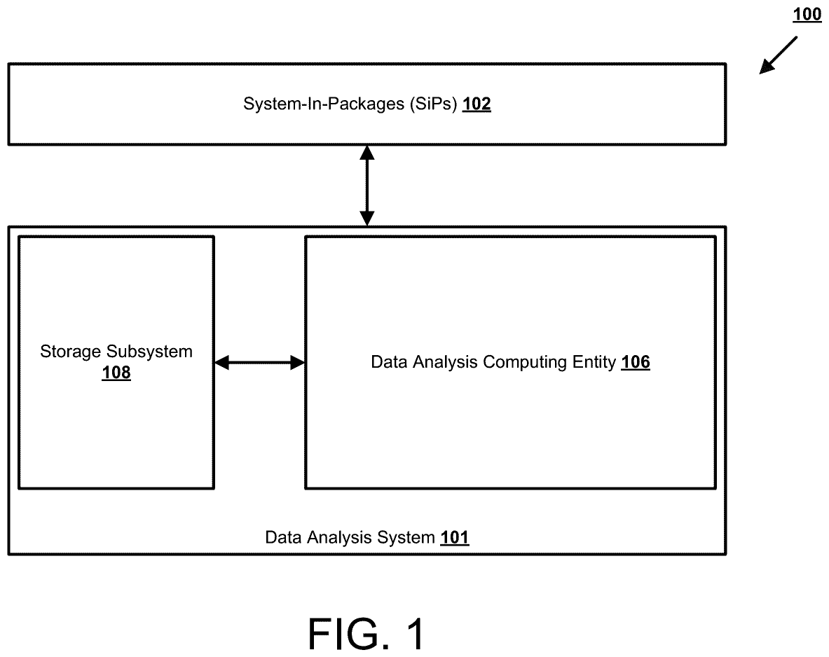

FIG. 1 is a schematic diagram of an example architecture 100. The architecture 100 includes a data analysis system 101 configured to receive one or more power traces comprising power side-channel switching activities from SiPs 102, process the one or more power traces from at least one of the SiPs 102 to generate reference power traces, train a machine learning model based on the reference power traces, and provide or program the SiPs 102 with the machine learning model.

In some embodiments, data analysis system 101 may communicate with the SiPs 102, via a bus or communication interface, for example. Alternatively, data analysis system 101 may communicate with the SiPs 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The data analysis system 101 may include a data analysis computing entity 106 and a storage subsystem 108. The data analysis computing entity 106 may be configured to receive one or more power traces from the SiPs 102, process the one or more power traces, generate reference power traces based on power side-channel switching activities of at least one of the SiPs 102, generate a machine learning model trained on the reference power traces, and provide the machine learning model to the SiPs 102. Data analysis system 101 may train the machine learning model to detect power anomalies based on the reference power traces.

The data analysis computing entity 106 may include, or be in communication with, one or more processing elements (also referred to as processors, processing circuitry, and/or similar terms used herein interchangeably). As will be understood, a processing element may be embodied in a number of different ways. For example, a processing element may be embodied as one or more complex programmable logic devices (CPLDs), microprocessors, multi-core processors, coprocessing entities, graphics processing units (GPUs), application-specific instruction-set processors (ASIPs), microcontrollers, and/or controllers. Further, a processing element may be embodied as one or more other processing devices or circuitry. The term circuitry may refer to an entirely hardware embodiment or a combination of hardware and computer program products. Thus, a processing element may be embodied as integrated circuits (ICs), application-specific integrated circuits (ASICs), FPGAs, programmable logic arrays (PLAs), hardware accelerators, other circuitry, and/or the like.

As will therefore be understood, a processing element may be configured for a particular use or configured to execute instructions stored in volatile or non-volatile media or otherwise accessible to the processing element. As such, whether configured by hardware or computer program products, or by a combination thereof, the processing element may be capable of performing steps or operations according to embodiments of the present disclosure when configured accordingly.

The storage subsystem 108 may be configured to store data, e.g., power traces received from at least one of the SiPs 102, in data structures that may be accessed by the data analysis computing entity 106 as training data. Storage subsystem 108 may also store weights and biases of a machine learning model trained based on the training data. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets.

Moreover, each storage unit in the storage subsystem 108 may include one or more non-volatile storage or memory or volatile storage or memory. The non-volatile storage or memory or volatile storage or memory may store databases, database instances, database management systems, data, applications, programs, program modules, scripts, source code, object code, byte code, compiled code, interpreted code, machine code, executable instructions, and/or the like to implement the functions of the processing element 104. As indicated, this may include an application that is one or more SiPs 102.

The non-volatile storage or memory may comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile storage or memory may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The volatile storage or memory may comprise random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like.

As will be recognized, the volatile storage or memory may be used to store at least portions of the databases, database instances, database management systems, data, applications, programs, program modules, scripts, source code, object code, byte code, compiled code, interpreted code, machine code, executable instructions, and/or the like being executed by, for example, a processing element associated with data analysis computing entity 106. Thus, the databases, database instances, database management systems, data, applications, programs, program modules, scripts, source code, object code, byte code, compiled code, interpreted code, machine code, executable instructions, and/or the like may be used to control certain aspects of the operation of the data analysis computing entity 106.

### Example System-In-Package

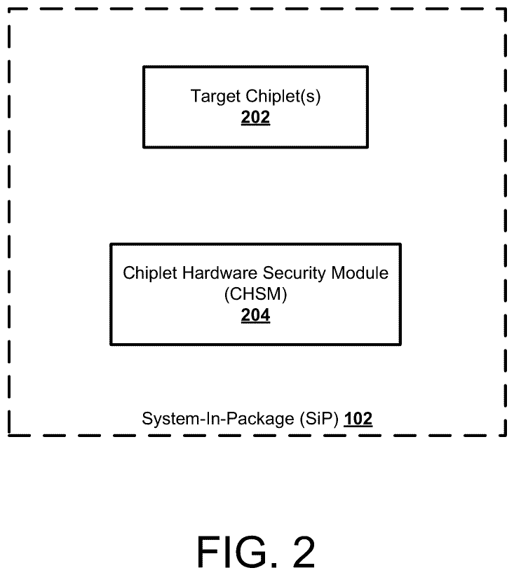

FIG. 2 provides a schematic of an example SiP device according to one embodiment of the present disclosure. A given one of the SiPs 102 comprises one or more target chiplet(s) 202 and a CHSM 204. The one or more target chiplet(s) 202 may comprise various different categories of flip-chip packaged chiplets, such as central processing units (CPUs), digital signal processors (DSPs), and memory devices. The CHSM 204 may comprise a configurable FPGA-based chiplet for detecting anomalies on a given one of SiPs 102 that may be induced by malicious activities from sources, such as software malware or hardware Trojan and fault injection attacks on the one or more target chiplet(s) 202.

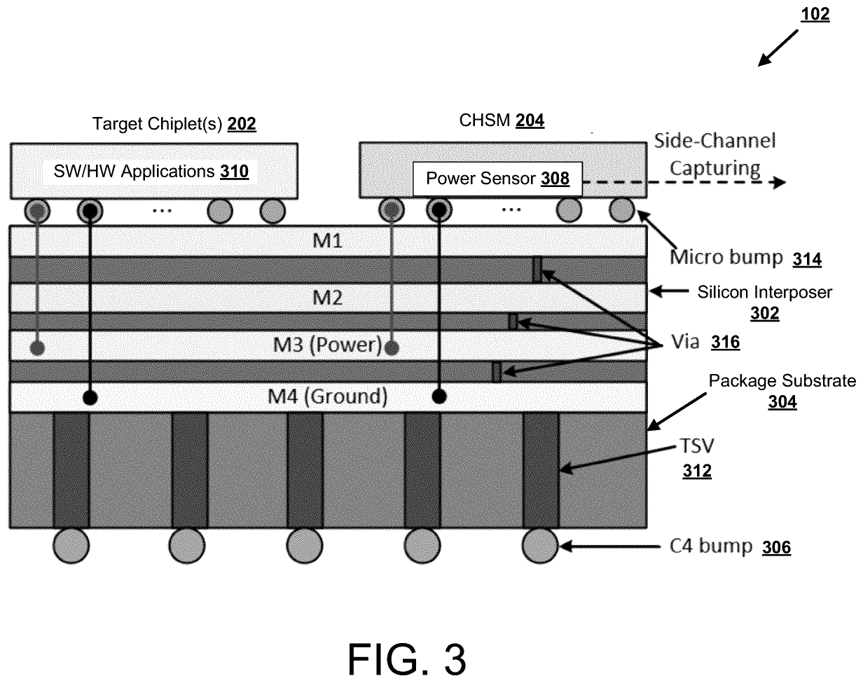

FIG. 3 depicts a cross-sectional view of an example SiP device. As depicted in FIG. 3, CHSM 204 is installed on top of silicon interposer 302 along with one or more target chiplet(s) 202 via micro bumps 314. Silicon interposer 302 comprises an interface with a package substrate 304. The silicon interposer 302 may comprise inter-chiplet interconnects (M1 and M3 metal layers) and a PDN (M3 and M4 metal layers) to unify and drive the one or more target chiplet(s) 202 and CHSM 204. As such, the one or more target chiplet(s) 202 may be integrated into a single system package to enable better power and performance density.

Via 316 may comprise an electrical connection between different layers of the silicon interposer 302. Furthermore, the package substrate 304 may be located underneath the silicon interposer 302 to interface the silicon interposer 302 with external board assembly level pitch input/output connections (C4 bump 306) using through-silicon vias (TSV) 312 to allow for vertical electrical routing.

According to various embodiments of the present disclosure, CHSM 204 may share a power supply connection via the PDN (e.g., M3 and M4 metal layers) with the one or more target chiplets without necessitating signal connectivity (e.g., M1 and M2 metal layers). CHSM 204 comprises a power sensor 308, which may be configured to capture power side-channel switching activities induced on a shared power plane of the PDN by software/hardware applications 310 of the one or more target chiplet(s) 202. In some embodiments, the power sensor 308 may comprise a time-to-digital converter (TDC) sensor. After integrating the CHSM 204 along with the one or more target chiplet(s) 202 on the interposer 302, SiP integrators may program the power sensor 308 to capture power fluctuations on the shared power plane which may be induced by switching activities of software/hardware applications 310 on the one or more target chiplet(s) 202. For example, hardware and/or software applications of the one or more target chiplet(s) 202 may be executed by turning underlying transistors on and off, and thus, drawing a unique spectrum of current from the power distribution network.

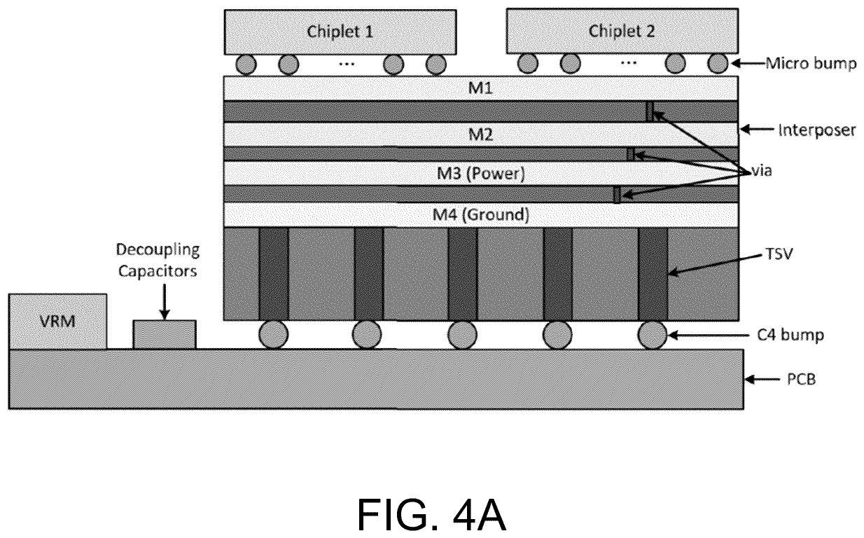

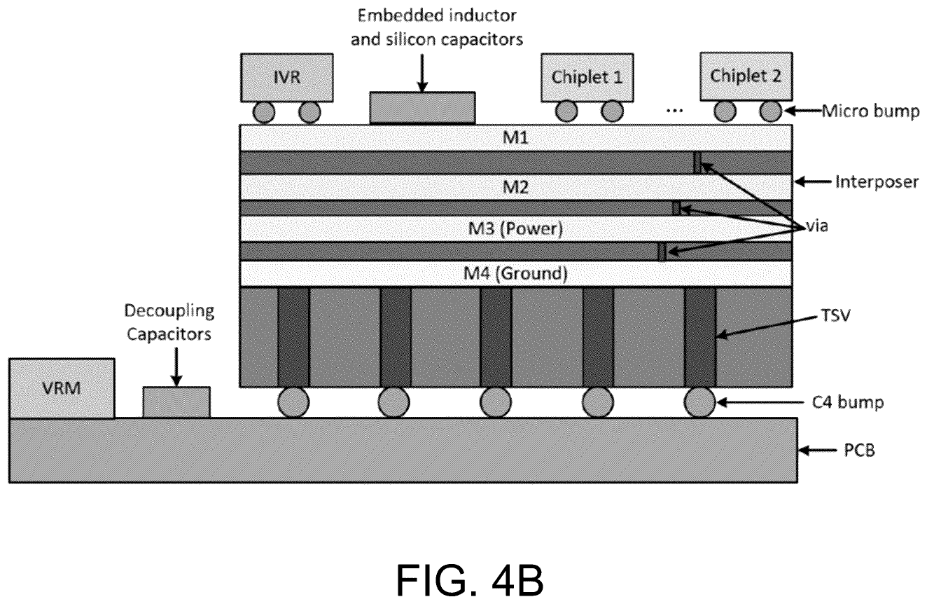

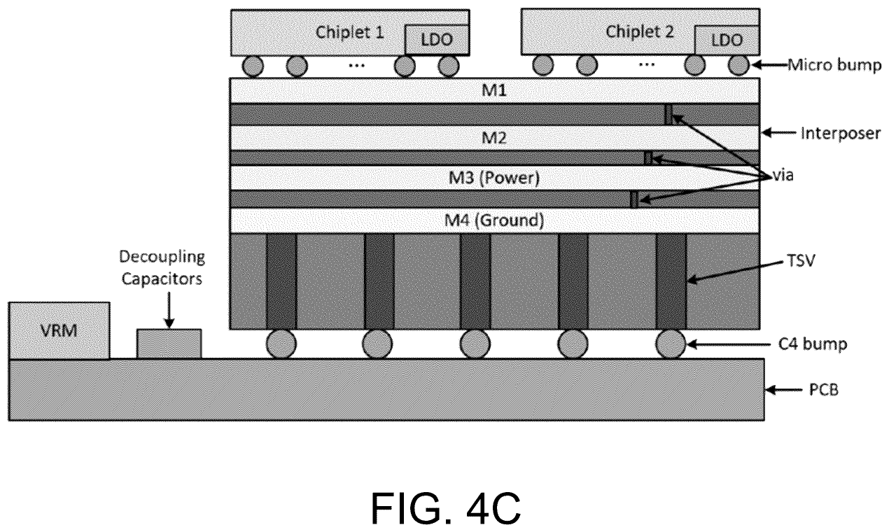

The power sensor 308 in CHSM 204 may be used to capture power fluctuations from a variety of SiP PDN configurations, as depicted in FIG. 4A, FIG. 4B, and FIG. 4C.

FIG. 4A depicts an example baseline SiP where external voltage regulator modules (VRM) and printed circuit board-level decoupling circuitry are available. In the depicted example, since the power plane is shared, power fluctuations originating from the switching activities of target chiplets should impact a CHSM power supply as well.

FIG. 4B depicts an example co-design SiP that optimizes PDN performance by taking both chiplet and interposer designs into account. The SiP depicted in FIG. 4B comprises an external voltage regulator module (VRM), PCB-level decoupling capacitors, an on-chip integrated voltage regulator (IVR) chiplet and embedded inductor and silicon capacitors to mitigate IR (current-resistance) drop issues. Despite alleviated power vibrations at the overall system level, a CHSM may still be able to sense local fluctuations in the absence of an on-chip decoupling circuitry to suppress impedance over a wide spectrum.

FIG. 4C depicts an example SiP where each chiplet comprises a low-dropout regulator (LDO) in addition to an external VRM and decoupling capacitors to compensate for voltage drop. A chiplet may pull varying amounts of currents depending on workload through the LDO, e.g., the load current, whereas the impact of LDO is its consumed ground current which is typically less than 1% of the load current and thus presents limited influence on input current to be measured by the power sensor 308 in CHSM 204.

### Example Chiplet Hardware Security Module

As previously discussed, a SiP may comprise one or more chiplets that may be victims of fault injection attacks during the in-field phase, rendering internal security assets vulnerable. According to various embodiments of the present disclosure a CHSM may be provided within the same SiP package as the one or more chiplet to enhance robustness against physical disturbances.

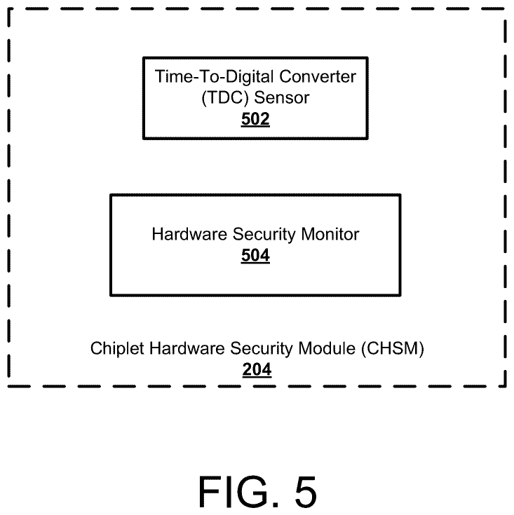

FIG. 5 provides an illustrative schematic representative of a CHSM 204 that may be used in conjunction with embodiments of the present disclosure. CHSM 204 may comprise a configurable FPGA-based chiplet or an IC comprising a form factor compatible with an interposer such that it may be assembled with other chiplets or ICs into a singular package, such as SiPs 102. As depicted in FIG. 5, CHSM 204 comprises a TDC sensor 502 and a hardware security monitor 504.

### Time-to-Digital Converter Sensor

TDC sensor 502 may comprise a device that may digitize the power-varying propagation delay of buffer primitives such that the power fluctuations at the SiP level may be captured. In some embodiments, the TDC sensor 502 may be configured to capture events and provide a digital representation of the occurrence of the events. According to various embodiments of the present disclosure, the TDC sensor 502 may be used to capture power side-channel switching activities by the one or more target chiplet(s) 202. In particular, the TDC sensor 502 may be configured to trace and measure power fluctuations on a power plane that is shared with, for example, one or more target chiplet(s) 202 on a given one of SiPs 102 and convert the traces of power fluctuations into digital outputs. The power fluctuations may be induced by, for example, hardware and/or software applications running on the one or more target chiplet(s) 202. As such, output generated by the TDC sensor 502 may interpret application executions (e.g., via transistor switching) of the one or more target chiplet(s) 202 by measuring data-dependent power usage associated with the one or more target chiplet(s) 202.

Output generated by TDC sensor 502 may be aggregated and analyzed to determine power fluctuation characteristics associated with applications executing on the one or more target chiplet(s) 202. In some embodiments, reference power traces may be generated based on the power fluctuations to establish a baseline associated with the one or more target chiplet(s) 202. The reference power trace may in turn be used to detect potential malicious anomalies of a SiP while deployed in-field. For example, while in the integration phase, CHSM 204 may be configured to generate reference power traces with TDC sensor 502 to train a machine learning model (e.g., by data analysis system 101). The machine learning model trained based on the reference power traces may be used to program a hardware security monitor 504, which may be configured to determine whether power traces captured by TDC sensor 502 associated with applications executing on the one or more target chiplet(s) 202 during runtime deviate from norm or expected power traces based on the reference power traces indicative of potential malicious activities. In some embodiments, the machine learning model trained based on reference power traces generated by TDC sensor 502 may be used to program the hardware security monitor 504 of one or more CHSMs 204. That is, a batch of one or more SiPs 102 comprising substantially similar or identical one or more target chiplet(s) 202 may be trained using reference power traces generated by a TDC sensor 502 associated with a representative one of the one or more SiPs 102.

TDC sensor 502 may be configured to digitalize time delay variations in a buffer path by mapping power-varying propagation delay of a buffer chain to generate digital words. By associating a delay amount of each buffer unit with a change in voltage (e.g., increase delay with a voltage drop), the digitalized time delay may serve as an indicator of voltage supply. As such, TDC sensor 502 may provide functionality of a lightweight on-chip oscilloscope within a SiP.

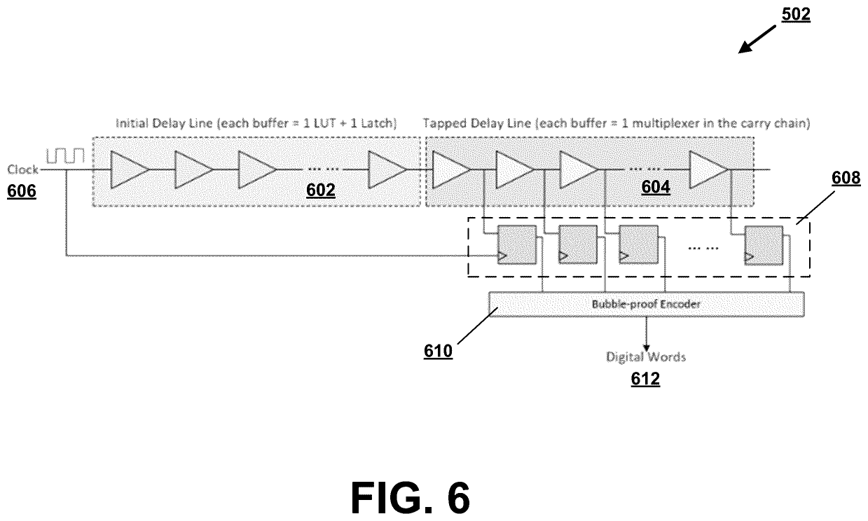

FIG. 6 depicts an example schematic representative of TDC sensor 502. As depicted in FIG. 6, TDC sensor 502 comprises a buffer path formed by a chain of buffers including an initial delay line 602 and a tapped delay line 604. A clock signal 606 is coupled to and drives both the buffer chain and tapped latches 608. The initial delay line 602 may be used to calibrate the position of the clock edge of clock signal 606 to allow tapped latches 608 to capture propagation distances and convert them to binary readings. The length of the initial delay line 602 may be calibrated according to a clock frequency and phase such that the clock failing edge is backward shifted by a predetermined amount, such as approximately half a period. Based on the calibration, the clock edge of clock signal 606 may be configured to a middle of the tapped delay line 604 (e.g., a 64-stage tapped delay line).

Clock signal 606, without any delay, may be configured to drive tapped latches 608 coupled with the tapped delay line 604. The propagation distance of the clock edge may thus be captured every cycle. For example, the value of the tapped delay line 604 cached by the tapped latches 608 may be a binary sequence of ‘000 . . . 0011 . . . 111’ comprising continuous 0's and where the clock edge is at the middle. When voltage drops occur, the amount of MOSFET current charging node capacitances may be reduced and consequently lead to slower node voltage changes, introducing power varying delay variations in the buffer chain of the TDC sensor 502. In turn, the location of the ‘0-1’ boundary in the registered values (e.g., stored by tapped latches 608) from the tapped delay line 604 may be changed by the occurrence of the voltage drop, which may quantify the power noise variations from running applications and potential power glitches one or more target chiplets.

As an example, given a clock period T, and the initial delay line 602 of the buffer path aims to postpone the clock signal 606 by a delay

$$D \approx N * \frac{T}{2}$$

where N is an odd integer such that the clock falling edge locates at the middle of the tapped delay line 604 when the tapped latches 608 capture the status as ‘11 . . . 1100 . . . 00’ every clock cycle, if there are power fluctuations from one or more target chiplets, a voltage drop may impact the power supply of the CHSM including the TDC sensor 502 as well. Accordingly, the voltage drop may increase the delay of each buffer in the buffer path and consequently impact the value of delay D to vary the outcome of the TDC sensor 502, (e.g., the location of the ‘1’ to ‘0’ transition in the binary sequence).

A bubble-proof encoder 610 is coupled to the output of tapped latches 608. Bubble-proof encoder 610 may comprise a thermometer-to-binary encoder with edge detection capability and able to counter possible issues of routing imbalance to yield binary encoding representations of power fluctuations. For example, the bubble-proof encoder 610 may enhance the reliability of output from tapped latches 608 by identifying the first ‘110’ sequence in the output of tapped latches 608 to exclude false positive ‘bubble’ scenarios, such as ‘11 . . . 11000001000 . . . 00’ where the lone ‘1’ value between the continuous ‘0s’ may not be a correct transition potentially because of an imbalanced routing delay. The bubble-proof encoder 610 may compress M-bit binary sequences captured by the tapped latches 608 to a ┌log 2 M┐-bit digital words 612 where M may represent the number of buffer stages in the tapped delay line 604 and correspondingly tapped latches 608.

Initial delay line 602 and tapped delay line 604 may comprise configurable primitives, such as look-up tables (LUTs). In some embodiments, LUT-latch pairs and multiplexers in the carry chain primitive of a CHSM in which the TDC sensor is embodied may be used to implement the buffer instances in the initial delay line 602 and the tapped delay line 604. For example, configuring the initial delay line 602 to shift the common clock signal by a delay D, its unit delay may be coarse-grained to provide enough amount of time shift for sensor calibration by using LUT-latch pairs and programming them as transparent components (e.g., the latches are always-activated while LUT initialization values are set in a way that the output equals its input). Fine-grained delay may also be provided by multiplexers in the carry chain primitive such that a falling edge position may be flexibly adjusted under nominal cases. As for the tapped delay line 604, a fine-grained unit delay is also desirable to enable high time resolution for precise measuring of variations in power fluctuations.

### Hardware Security Monitor

Hardware security monitor 504 may be configured to detect anomalies induced by malicious activities during runtime of a SiP comprising the hardware security monitor 504 (e.g., a given one of SiPs 102 installed with a CHSM 204 comprising the hardware security monitor 504) by analyzing traces generated by TDC sensor 502 of power fluctuations associated with applications executing on the one or more target chiplet(s) 202. The hardware security monitor 504 may be very flexible, modular, and configurable regarding submodules and parameters, for example, the hardware security monitor 504 may be updated during run-time using a dynamic reconfiguration port feature.

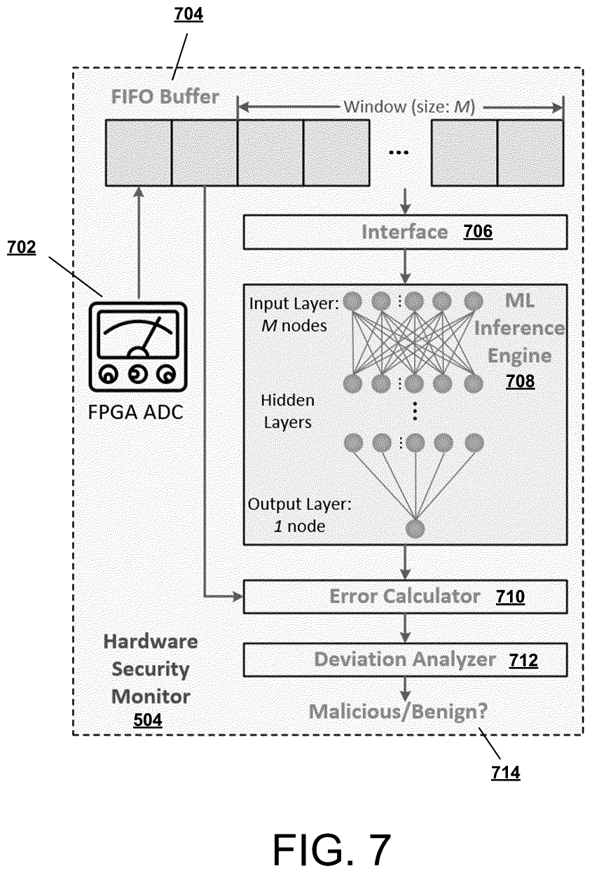

FIG. 7 depicts an example schematic representative of hardware security monitor 504. As depicted in FIG. 7, hardware security monitor 504 comprises FPGA analog-to-digital converter (ADC) input 702, first in, first out (FIFO) buffer 704, interface module 706, machine learning inference engine 708, error calculator 710, and deviation analyzer module 712. FPGA ADC input 702 comprises an interface configured to receive data samples from, for example, TDC sensor 502. Data samples received at FPGA ADC input 702 may comprise traces of power fluctuations monitored and captured during run-time of a SiP comprising the hardware security monitor 504. For example, one of SiPs 102 may comprise one or more target chiplet(s) 202 and a CHSM 204, where (i) the CHSM 204 comprises a TDC sensor 502 coupled to a hardware security monitor 504 and (ii) the TDC sensor 502 is configured to provide traces of power fluctuations associated with the one or more one or more target chiplet(s) 202 to the hardware security monitor 504 via FPGA ADC input 702.

Data samples received via FPGA ADC input 702 may be stored into and buffered by the FIFO buffer 704. When the FIFO buffer 704 is full, the machine learning inference engine 708 may read data from FIFO buffer 704 and generate predictions accordingly. In some embodiments, the interface module 706 may load a window of M data samples from the FIFO buffer 704 into the machine learning inference engine 708, where M may represent a number of neurons in the input layer of a machine learning model associated with the machine learning inference engine 708. The machine learning inference engine 708 may then utilize the loaded data samples to predict a value of a next sample, M+1, based on learned golden patterns. In some embodiments, the learned golden patterns may comprise weights and biases of a machine learning model associated with machine learning inference engine 708 that are trained on reference power traces, as disclosed herewith. The interface module 706 may also be configured to coordinate control/status signals between FIFO buffer 704 and the machine learning inference engine 708. In some embodiments, FIFO buffer 704 may be continuously updated with data from FPGA ADC input 702 in real-time. As such, interface module 706 may continuously load new values from the window of M data samples from the FIFO buffer 704 into machine learning inference engine 708 where machine learning inference engine 708 may predict respective M+1 values.

Error calculator 710 may be configured to compare a value of M+1 predicted by machine learning inference engine 708 with an actual value of M+1 from FIFO buffer 704. As such, the error calculator 710 may compare predictions from the machine learning inference engine 708 with ground truth (e.g., the digitized value of the TDC sensor from the FIFO buffer 704) to determine an amount of difference (or error) between predicted values and actual values. In an example embodiment, a difference between a predicted value of M+1 and an actual value of M+1 may be generated as a numerical output by the error calculator 710 and received by deviation analyzer module 712.

Deviation analyzer module 712 may be configured to identify whether any attack-induced anomalies exist based on the difference between the predicted and actual values of M+1 generated by error calculator 710. In some embodiments, the deviation analyzer module 712 may compare the difference with a threshold to tolerate measurement and attack-irrelevant errors. That is, if a deviation between the prediction and the ground truth exceeds the pre-defined threshold, a malicious attack is detected.

In some embodiments, the deviation analyzer module 712 may be configured to cache output (e.g., the difference between prediction and ground truth) from error calculator 710 to an error buffer over a sliding time frame. The values accumulated in the error buffer may be used to determine an accumulated error value over the sliding time frame. The accumulated error value may be compared with an error value threshold. If the accumulated error value exceeds the error value threshold, an error amount counter may be incremented. A malicious attack may be detected if the error counter exceeds a number of errors threshold, Nₑᵣᵣ. A detection of a malicious attack may require triggering subsequent policies, such as clearing security-critical assets and/or power-cycling the entire system. Otherwise, if the deviation does not exceed the pre-defined threshold, the deviation may be identified as benign.

### Example System Operations

Various embodiments of the present disclosure describe steps, operations, processes, methods, functions, and/or the like for detecting malicious attacks on a SiP during runtime by using a machine learning model. Power traces of running applications in time-series form may be fed to and used to train a machine learning model to yield a model fitted to golden application behaviors. The trained machine learning model may then be converted to hardware accelerators at a register-transfer level (RTL) using techniques, such as high-level synthesis (HLS). For example, if the hardware platform is an FPGA chiplet (e.g., CHSM), one or more hardware accelerators may be mapped as FPGA bitstreams along with a TDC sensor and other anomaly detection circuitry to create a CHSM.

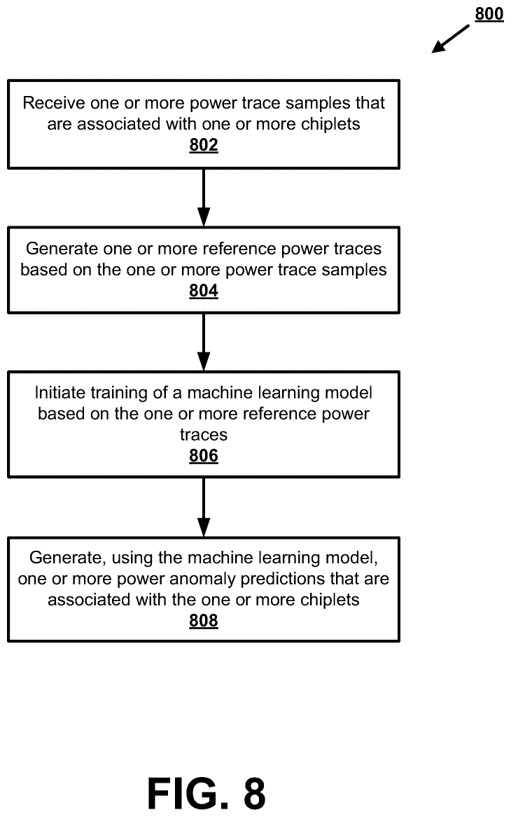

FIG. 8 is a flowchart diagram of an example process 800 for providing runtime security of a hardware device in accordance with some embodiments of the present disclosure.

In some embodiments, the process 800 begins at step/operation 802 when the CHSM 204 receives one or more power trace samples that are associated with one or more chiplets. According to various embodiments of the present disclosure, the one or more power trace samples are representative of power side-channel switching activities that are associated with one or more chiplets. The one or more chiplets may be (i) communicatively coupled to the CHSM 204 and (ii) configured within a SiP along with the CHSM 204. The one or more power trace samples may be received from a sensor, such as TDC sensor 502 that is configured to provide functionality of a lightweight on-chip oscilloscope within a SiP, as described herein. The one or more power trace samples may capture power fluctuations on a power plane that is shared with, for example, the one or more chiplets on the SiP.

In some embodiments, at step/operation 804, the CHSM 204 generates one or more reference power traces based on the one or more power trace samples. The one or more reference power traces may comprise one or more baseline power signatures of hardware and/or software applications running on potential victim chiplets (e.g., the one or more chiplets). In some embodiments, generating the one or more reference power traces comprises aggregating and analyzing one or more power trace samples to determine power fluctuation characteristics associated with applications executing on the one or more chiplets.

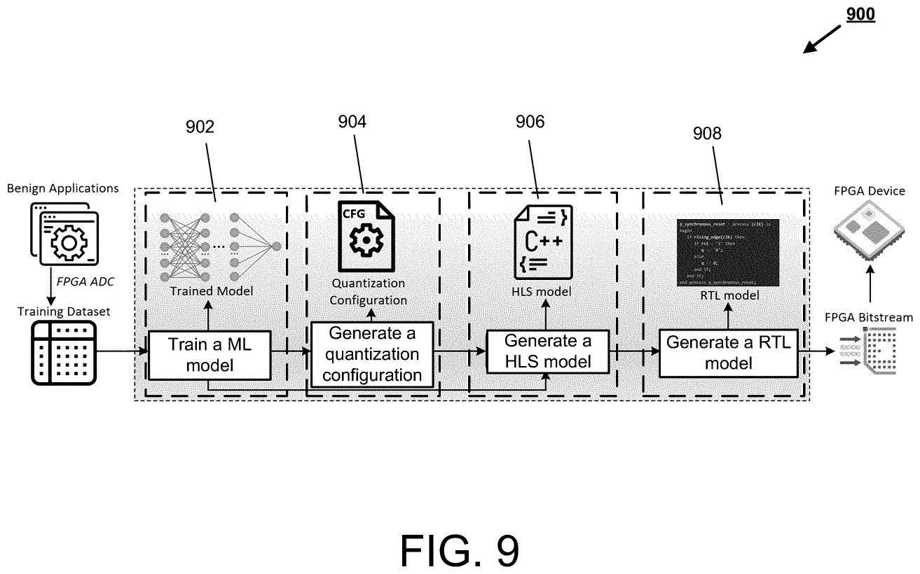

In some embodiments, at step/operation 806, the CHSM 204 initiates training of a machine learning model based on the one or more reference power traces. In some embodiments, the one or more reference power traces may be provided to a machine learning model as training data comprising power profiles in the form of time series to yield a model fitted to golden application behaviors. According to various embodiments, the CHSM 204 may be configured to generate reference power traces (e.g., with TDC sensor 502) and provide the reference power traces to train a machine learning model (e.g., via data analysis system 101) during an application profiling phase process. For example, one or more reference power traces may be provided to data analysis system 101 for analysis during application profiling in an integration phase of a SiP by inputting the one or more reference power traces to a machine learning model as training data. In some embodiments, the data analysis system 101 uses the one or more reference power traces to train a machine learning model to detect power anomalies (e.g., indicative of a malicious attack). As such, the machine learning model may be used for security monitoring of a SiP while deployed in-field by detecting potential malicious anomalies. Application profiling is described in further detail with reference to the description of FIG. 9.

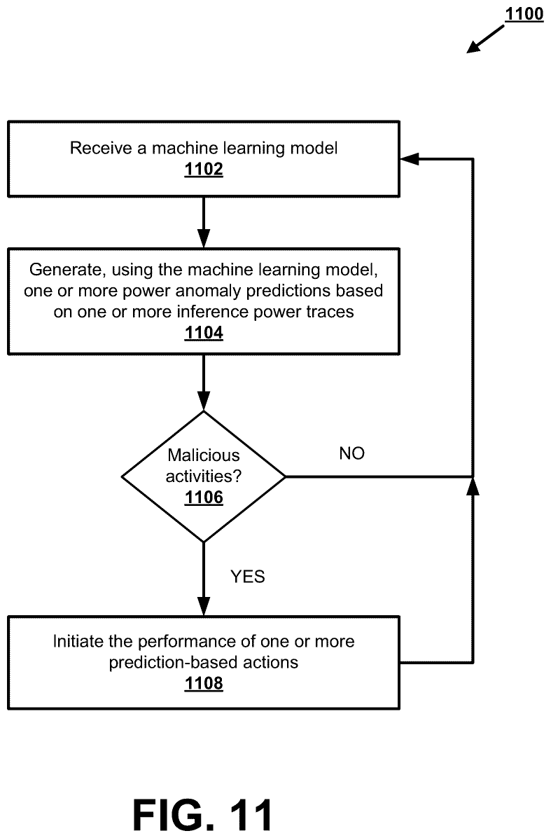

In some embodiments, at step/operation 808, the CHSM 204 generates, using the trained machine learning model, one or more power anomaly predictions that are associated with the one or more chiplets. Generating the one or more power anomaly predictions may comprise using the trained machine learning model to monitor inference power traces of the one or more chiplets for characteristics that are abnormal or consistent with malicious attacks. According to various embodiments of the present disclosure, the CHSM 204 may program a hardware security monitor 504 with the trained machine learning model to configure the hardware security monitor 504 for security monitoring. The trained machine learning model may be provided to the CHSM 204 by the data analysis system 101, for example, after an application profiling phase process. In some embodiments, security monitoring comprises determining whether power traces associated with applications executing on the one or more chiplets during runtime (e.g., in-field phase) deviate from norm or expected power traces based on the reference power traces indicative of potential malicious activities. Monitoring the one or more chiplets for one or more potential power anomalies is described in further detail with reference to the description of FIG. 11.

### Application Profiling

FIG. 9 is a flowchart diagram of an example process 900 for application profiling in accordance with some embodiments of the present disclosure.

In some embodiments, the process 900 begins at step/operation 902 when the data analysis system 101 trains a machine learning model based on a training dataset. In some embodiments, training a machine learning model comprises receiving a training dataset, providing the training dataset as input to fit (e.g., via deep learning training) a target machine learning model, and generating one or more model parameters based on the target machine learning model's interpretation of the training dataset with respect to a target classification. The training dataset may comprise pre-processed reference power traces that are associated with one or more specified applications executing on one or more chiplets. In some embodiments, the machine learning model may comprise a multi-layer perception (MLP) feedforward artificial neural network. A MLP may comprise an input layer of M nodes (neurons), multiple hidden layers L=[l₁, l₂, . . . , l_{K}] where K may refer to the number of hidden layers while lₖ may represent the number of neurons in the i^{th} layer (1≤k≤K), an output layer of a single neuron. An individual neuron may be expressed as:

$${y}_{i} = ∅ [ {\sum }_{n = 1}^{N} ( {x}_{n} \cdot {w}_{n} ) + {b}_{i} ] \qquad Equation 1$$

where xₙ, wₙ, and bᵢ may represent data samples, weights, and biases of a layer that the neuron locates, respectively. ϕ(⋅) may represent an activation function to empower the non-linearity of the MLP for fitting complicated patterns. In some embodiments, rectified linear unit (ReLU) may be used as the activation function for faster computation and reduction of the likelihood of vanishing gradient problems. As an optimization problem, the error may need to be measured at each round to provide feedback to the optimizer and mean squared error (MSE) may be used.

In some embodiments, the training dataset may be interfaced with a MLP machine learning model by shifting a M-size sliding window through the reference power trace producing a number of M-to-1 tuples, e.g., using current M samples to predict the next one. Samples may be reconciled by using Equation 2 where s_{raw} may represent a raw sample while TDCₘₐₓ may represent an upper limit of sensor (e.g., TDC sensor 502) readings, i.e., the taps of the observable delay line in the sensor.

$${s}_{processed} = \frac{{s}_{raw}}{{TDC}_{max}} \qquad Equation 2$$

As such, the training dataset may be built and fed into the MLP machine learning model. The training procedure may be automated and parallelized with mainstream deep learning frameworks such as Tensorflow on a data analysis system 101. The trained model (e.g., in h5 or JSON formats) may be exported for use in model parameter profiling and HLS model conversion in subsequent steps/operations 904 and 906, respectively.

In some embodiments, at step/operation 904, the data analysis system 101 generates a quantization configuration based on one or more model parameters of the machine learning model.

In some embodiments, generating the quantization configuration comprises profiling one or more model parameters of the trained machine learning model and quantizing the trained machine learning model from floating-point to its fixed-point counterpart. For example, fixed data types may be determined for each layer of the trained machine learning model based on floating-point values of trained model parameters, such as weights and bias, of each neuron of the layer.

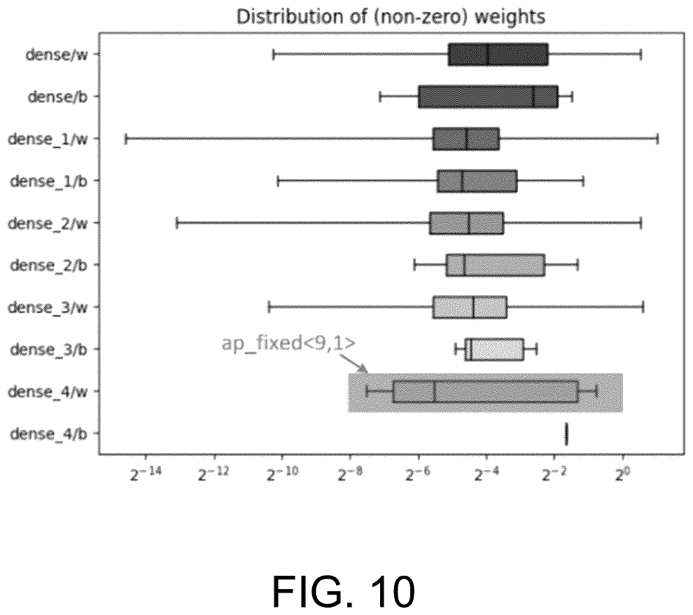

Referring to FIG. 10, an example model parameter (weights and biases) profiling boxplot of a trained MLP machine learning model with an input layer, three hidden layers and an output layer (from dense/w,b to dense 4/w,b) is depicted. The X-axis of the boxplot represents a numerical range of model parameters, and the Y-axis of the boxplot represents weights/biases of neurons in a specific layer. Distributions of non-zero numerical values of weights and biases may be used to determine quantization. Floating-point model parameters may be converted into fixed-point data types, such as ap_fixed{W, I} which may represent a W-bit signed word comprising I-bit integer bits and (W−I)-bit fractional bits. For example, the weight distribution of neurons in the output layer (dense 4/w) ranges from 0.005 to 0.598, falling within the range from 2-8 to 20 and thus may be mapped to the fixed-point data type ap_fixed{9, 1}. It is worth noting that the fixed-point data type may cover the maximum of the absolute valued weights/biases to preserve model precision. According to the parameter profiling results, a quantization configuration may be generated for each layer to determine their optimal fixed-point data types.

Referring back to FIG. 9, in some embodiments, at step/operation 906, the data analysis system 101 generates an HLS model based on the machine learning model and the quantization configuration. An HLS framework, such as the HLS4ML framework, may be provided with the quantization configuration and the floating-point trained machine learning model as inputs to generate a fixed-point HLS model in, for example C/C++. In addition to the quantization configuration, a reuse factor that indicates a number of times a multiplier may be operated to compute the outputs of a layer may be selected to generate the HLS model. Given that resource bottleneck of an FPGA is the multipliers within DSP slices in most cases, the reuse factor may be used to strike a balance between resource utilization and latency.

In some embodiments, at step/operation 908, the data analysis system 101 generates an RTL model based on the HLS model. Generating the RTL model may comprise porting the HLS model to, for example, HLS tools to yield corresponding RTL implementation of the HLS model. The RTL model may be compiled to a FPGA bitstream for a machine learning inference engine of a CHSM (e.g., CHSM 204).

### Security Monitoring

FIG. 11 depicts a flowchart diagram of an example process 1100 for security monitoring in accordance with some embodiments of the present disclosure.

In some embodiments, the process 1100 begins at step/operation 1102 when the CHSM 204 receives a machine learning model. According to various embodiments of the present disclosure, the CHSM 204 may be embedded within a SiP (e.g., a given one of SiPs 102) to provide for on-chip runtime security monitoring. The machine learning model may be generated and trained via an application profiling process, as described herein. In some embodiments, receiving the machine learning model further comprises loading the machine learning model to a hardware security monitor (504) component of the CHSM 204. In some embodiments, the machine learning model may be converted to hardware accelerators at the register-transfer level (RTL) using techniques, such as HLS. For example, if the hardware platform is an FPGA chiplet, the hardware accelerator may be mapped as bitstreams along with a TDC sensor 502 and a hardware security monitor 504, or other anomaly detection circuitry.

In some embodiments, at step/operation 1104, the CHSM 204 generates, using the machine learning model, one or more power anomaly predictions based on one or more inference power traces. In some embodiments, generating the one or more power anomaly predictions comprises receiving or determining (e.g., by TDC sensor 502) the one or more inference power traces based on power noise variations that are associated with applications executing on one or more chiplets of a SiP during an in-field phase (e.g., when the SiP is placed into a potentially hostile network and/or a physical environment). In some embodiments, the one or more power traces comprise runtime power fluctuations that are compared with expected power fluctuations and/or ground truths via the machine learning model. For example, the machine learning model may be trained based on training data that comprises a labeled dataset comprising “golden” behaviors of one or more reference power traces that are labeled with normal behavior, malware, Trojan, fault injection, or other malicious attack-induced anomalies. In some embodiments, generating the one or more power anomaly predictions comprises using the machine learning model to determine (i) deviations from normal behavior, (ii) similarities to malicious attacks, and/or (iii) deviations between expected behaviors and actual behaviors.

In some embodiments, at step/operation 1106, the CHSM 204 monitors for malicious activity based on the one or more power anomaly predictions. The CHSM 204 may continuously receive and monitor power traces for malicious activity via the one or more power anomaly predictions during runtime of the SiP.

In some embodiments, if one or more malicious activities are detected, at step/operation 1108, the CHSM 204 initiates the performance of one or more prediction-based actions. In some embodiments, the one or more prediction-based actions comprise triggering one or more preventative or remediation procedures, such as clearing security-critical assets and power cycling an entire system.

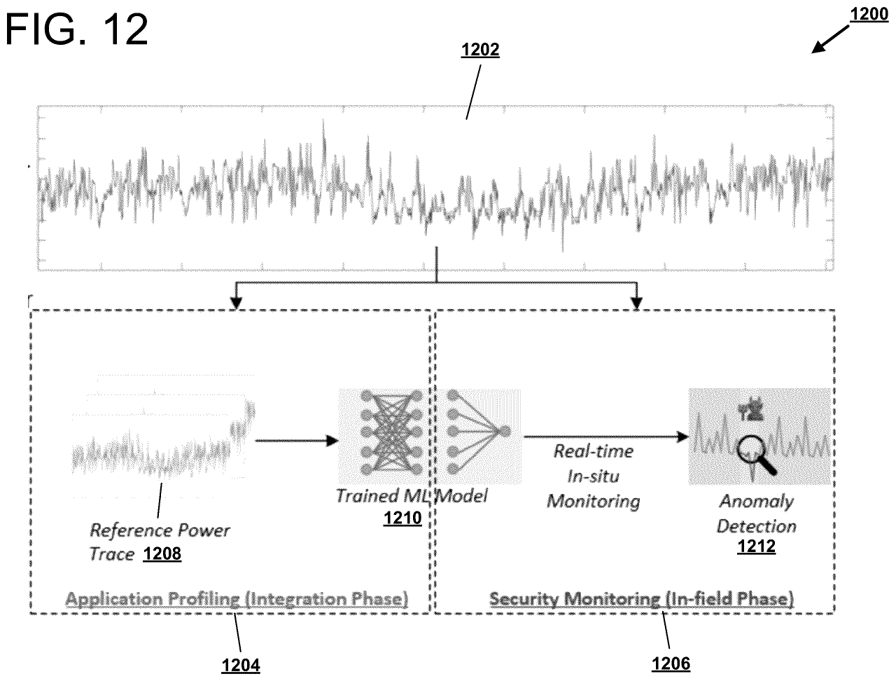

FIG. 12 depicts an operational example of a security monitoring architecture 1200 using power traces obtained from a TDC sensor. Power traces 1202 may be representative of power side-channel switching activities associated with one or more target chiplets. For example, power noise variations in a PDN of a given one of SiPs 102 may originate from underlying transistors on/off behaviors and consequent different spectrums of required currents according to running applications, for example of one or more target chiplet(s) 202. In other words, traces of power fluctuations in the PDN may serve as signatures of the targeted applications.

The power traces 1202 may be generated by a power sensor 308 of a CHSM 204 installed on the SiPs 102 and used for application profiling during an integration phase (1204) and security monitoring during an in-field phase (1206). The integration phase 1204 may comprise a stage during integration time when the SiPs 102 are assembled. It may be assumed that at integration time, SiPs 102 are fabricated and assembled by trusted teams and foundries in a trusted facility such that adversaries do not have access or proximity to the SiPs 102. As such, SiPs 102 during integration time may comprise chiplets with software applications that are free from control-flow integrity violations and hardware applications that are either Trojan-free or Trojan dormant. Given that SiPs may be assumed to be free from threats during integration time, power traces collected by a TDC sensor in this stage may be utilized as the golden reference to detect deviations induced by attacks during in-field operations.

Reference power traces 1208 in the form of time series may be fed into machine learning model 1210 to yield a model fitted to golden application behaviors. According to various embodiments of the present disclosure, power traces generated by a TDC sensor of a CHSM 204 from at least one of the SiPs 102 may be received by data analysis system 101 to generate reference power traces (1208) during integration phase 1204. Reference power traces 1208 may comprise baseline power signatures of hardware and/or software applications running on potential victim chiplets (e.g., one or more target chiplet(s) 202). In some embodiments, power signatures of benign applications may be acquired as reference power traces 1208 for establishing a basis of system integrity violations. As such, power fluctuations of representative one or more of (e.g., either a batch of) the SiPs 102 may be profiled as baseline behaviors of the applications and stored as reference patterns via the reference power traces 1208. Reference power traces 1208 may be analyzed during application profiling in the integration phase 1204 and provided to machine learning model 1210 as training samples (data), for example, by data analysis system 101. Data analysis system 101 may train the machine learning model 1210 to detect power anomalies (indicative of a malicious attack) based on the reference power traces.

The machine learning model 1210, generated by application profiling during integration phase 1204, may be loaded to, e.g., a hardware security monitor 504 in CHSM 204. In some embodiments, the machine learning model 1210 may be converted to hardware accelerators at the register-transfer level (RTL) using techniques, such as HLS. For example, if the hardware platform is an FPGA chiplet, the hardware accelerator may be mapped as bitstreams along with TDC sensor and other anomaly detection circuitry. CHSM 204 may be installed on one or more SiPs 102 to provide security monitoring functionality during in-field phase 1206, as described herein. The in-field phase 1206 may comprise a stage during in-field operations or runtime of the SiPs 102, for example, when the SiPs 102 are placed into a potentially hostile network and/or a physical environment. Machine learning model 1210 may be utilized by CHSM 204 in the SiPs 102 to generate predictions for anomaly detection 1212 during security monitoring in the in-field phase 1206.

In some example embodiments, CHSM 204 may be configured to generate and monitor power traces of executing applications on one or more target chiplet(s) 202 with a TDC sensor during the in-field phase 1206. The TDC sensor may be triggered by an electrical signal from the one or more target chiplet(s) 202 under monitoring for trace-behavior synchronization. In some embodiments, digital readings of the TDC sensor are stored in an L-sample FIFO buffer. When the FIFO buffer is full, the first M elements may be retrieved from the FIFO buffer by an interface module. M may be equal to the number of neurons in the input layer of the machine learning model 1210 used to analyze the digital readings. The machine learning model 1210 may continuously digest data from the FIFO buffer to generate predictions.

Anomaly detection 1212 may comprise predictions of malicious activity based on runtime power fluctuations captured by the TDC sensor that deviate from expected power fluctuations and ground truths as determined by the hardware security monitor 504 (e.g., based on reference power traces 1208). As such, CHSM 204 may continuously collect and monitor power traces during runtime for deviations in the power traces at the application level from “golden” behaviors of the reference power traces indicative of malware, Trojan, fault injection, or other malicious attack-induced anomalies. After training, the machine learning model 1210 may yield predictions according to the run-time power fluctuations from the TDC sensor to detect malicious attacks if substantial deviations between predictions and ground truths are determined. The predictions generated by the machine learning model 1210 may then be used for error calculation against the ground truth from the FIFO buffer. Differences between predictions and respective ground truths may be aggregated to determine an accumulated error value over a sliding time frame. The accumulated error value may be compared with an error value threshold to determine anomalous points.

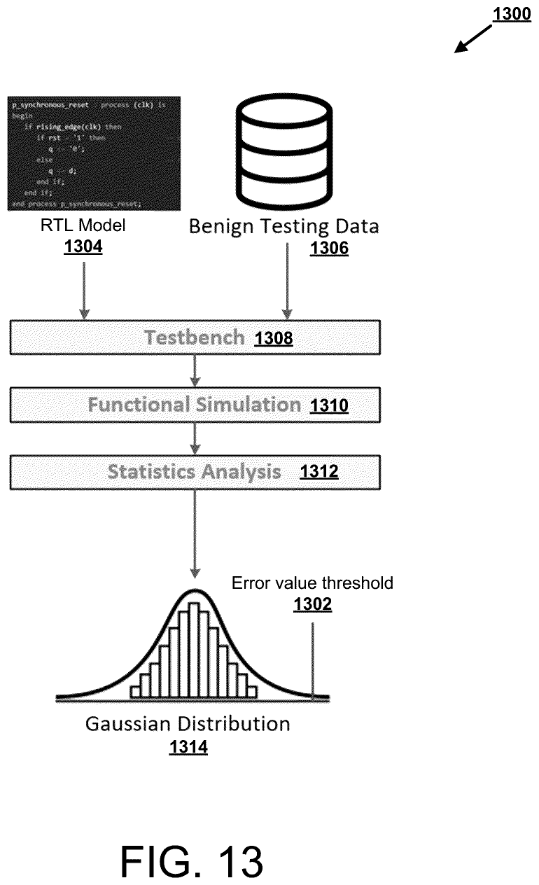

FIG. 13 depicts an example error value threshold determination framework 1300 in accordance with some embodiments of the present disclosure. As depicted in FIG. 13, an error value threshold 1302 may be determined by using a testbench 1308 to generate a functional simulation 1310 based on an RTL model 1304 (e.g., of a trained machine learning model as described herein) and benign testing data 1306. Error metrics based on predictions from the RTL model 1304 may be fitted into statistical distribution. As such, errors may be quantified for statistics analysis 1312, subject to a Gaussian distribution 1314, and thus, a numeric value of an error value threshold 1302 may be determined by following a 3-a rule to yield a 99.7% confidence, minimizing false positive cases.

If an accumulated error value exceeds the error value threshold 1302, an anomalous point may be identified, and an error amount counter may be incremented. A malicious attack may be detected if the error counter exceeds a number of errors threshold, Nₑᵣᵣ. The number of errors threshold, Nₑᵣᵣ may represent a minimum percentage of anomalous points out of samples from the sliding time frame. A detection of a malicious attack may require triggering subsequent policies, such as clearing security-critical assets and/or power-cycling an entire system. In an example embodiment, if deviations associated with a given one of SiPs 102 are quantified to exceed pre-defined thresholds, corresponding countermeasures may be triggered to protect the given one of SiPs 102 from being compromised. Otherwise, if the deviation does not exceed the pre-defined threshold, the deviation may be identified as benign.

In various embodiments, the CHSM 204 may be embodied as an artificial intelligence (AI) computing entity. In certain embodiments, an AI computing entity may comprise one or more predefined and executable program algorithms stored within an onboard memory storage module of CHSM 204. In various embodiments, the AI computing entity may be configured to retrieve and/or execute one or more of predefined program algorithms upon the occurrence of a predefined trigger event.

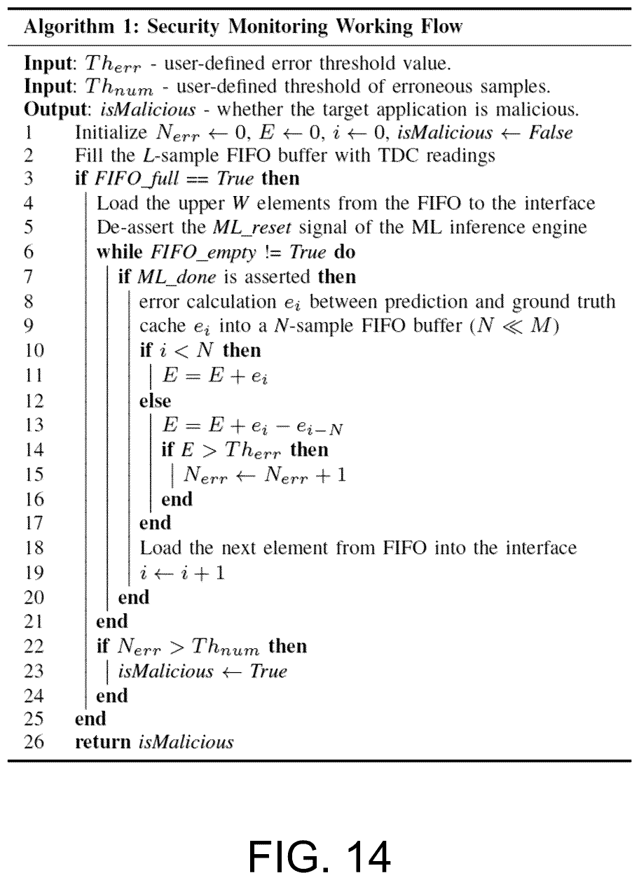

FIG. 14 is an example algorithm for performing security monitoring in accordance with some embodiments of the present disclosure.

Lines 1-5: A TDC sensor may be triggered (i) by an electrical signal from a chiplet under monitoring or (ii) for analyzing a captured waveform for trace-behavior synchronization. Digital readings of the TDC sensor may be stored in an L-sample FIFO buffer. M may represent a number of neurons in the input layer of a machine learning (ML) inference engine and may be determined by a sampling frequency and a time interval to be monitored. If the L-sample FIFO buffer is full, the first W elements may be loaded from the L-sample FIFO buffer to an interface. The interface may be responsible for hand-shaking control/status signals between the L-sample FIFO buffer and the ML inference engine as well as pre-processing incoming TDC readings if necessary. The ML inference engine may be activated by resetting a ML reset signal to generate predictions according to trained model parameters.

Lines 6-21: The activated ML inference engine may continuously digest data from the L-sample FIFO buffer until the L-sample FIFO buffer is empty (e.g., line 6). A prediction may be generated and used for error calculation against ground truth stored in the L-sample FIFO buffer. An error eᵢ may be cached in a N-sample FIFO inside a deviation analyzer module with size N (N<<M). The error eᵢ may be accumulated to E before the N-sample FIFO is not full. Otherwise, E may be updated by E=E+eᵢ+e_{i-N} such that the N-sample FIFO behaves as a moving filter which may provide better distinguishability between benign and malicious cases. The moving filter may comprise a lightweight and effective technique to remove random interference during security monitoring. If the accumulated E exceeds a user-defined input Thₑᵣᵣ, a timestamp may be identified as an anomalous point, e.g., incrementing the Nₑᵣᵣ register by 1.

Lines 22-26: To further circumvent false-positives, another user-defined threshold, Thₙᵤₘ, may be used to represent a minimum percentage of anomalous points out of samples from the N-sample FIFO. As such, the target running application in the chiplet under monitoring may be classified as a malicious case (e.g., Nₑᵣᵣ>Thₙᵤₘ) or benign as indicated by the isMalicious signal.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A system-in-package device comprising:
one or more target chiplets comprising one or more applications; and
a chiplet hardware security module (CHSM), the CHSM comprising:
a time-to-digital converter (TDC) sensor configured to generate one or more power traces associated with the one or more applications; and
a hardware security monitor configured to determine a presence of malicious attacks based on the one or more power traces.

2. The system-in-package of claim 1, wherein the TDC sensor is configured to generate the one or more power traces by digitizing power-varying propagation delay of buffer primitives that are associated with power side-channel switching activities by the one or more target chiplets.

3. The system-in-package of claim 1, wherein the TDC sensor is further configured to generate reference power traces.

4. The system-in-package of claim 3, wherein the hardware security monitor comprises a machine learning model trained based on the reference power traces.

5. The system-in-package of claim 4, wherein the machine learning model is configured to determine whether runtime power traces associated with the one or more applications deviate from the reference power traces.

6. The system-in-package of claim 4, wherein the hardware security monitor comprises:
an analog-to-digital converter (ADC) input configured to receive data samples from the TDC sensor;
a first in, first out (FIFO) buffer configured to store the data samples from the ADC input;
an interface module configured to load a window of data samples from the FIFO buffer into a machine learning inference engine;
the machine learning inference engine (i) comprising the machine learning model and (ii) configured to predict a value of a next sample with respect to the window of data samples;
an error calculator configured to determine a difference between the predicted value of the next sample with an actual value of the next sample from the FIFO buffer; and
a deviation analyzer module configured to determine a presence of attack-induced anomalies based on the difference.

7. The system-in-package of claim 6, wherein the deviation analyzer module is further configured to compare the difference with a threshold.

8. The system-in-package of claim 6, wherein the deviation analyzer module is further configured to:
cache the difference to an error buffer; and
determine an accumulated error value based on the cache difference.

9. The system-in-package of claim 8, wherein the deviation analyzer module is further configured to:
compare the accumulated error value with an error value threshold;
determine the accumulated error value exceeds the error value threshold; and
increment an error amount counter based on the accumulated error value exceeding the error value threshold.

10. The system-in-package of claim 9, wherein the deviation analyzer module is further configured to:
determine the error amount counter exceeds a number of errors threshold; and
determine the presence of attack-induced anomalies based on the error amount counter exceeding the number of errors threshold.

11. A computer-implemented method comprising:
receiving, by one or more processors that are (i) communicatively coupled to one or more chiplets and (ii) comprised within a system-in-package device that comprises the one or more chiplets, one or more power trace samples that are associated with the one or more chiplets;
generating, by the one or more processors, one or more reference power traces based on the one or more power trace samples;
initiating, by the one or more processors, training of a machine learning model based on the one or more reference power traces; and
generating, by the one or more processors and using the machine learning model, one or more power anomaly predictions that are associated with the one or more chiplets.

12. The computer-implemented method of claim 11, wherein the one or more power trace samples are representative of power side-channel switching activities that are associated with one or more chiplets.

13. The computer-implemented method of claim 11 further comprising receiving the one or more power trace samples from a time-to-digital converter sensor that is configured on the system-in-package device.

14. The computer-implemented method of claim 11, wherein the one or more power trace samples comprise one or more power fluctuations on a power plane that is shared with the one or more chiplets.

15. The computer-implemented method of claim 11, wherein the one or more reference power traces comprise one or more baseline power signatures of one or more hardware or software applications that are associated with the one or more chiplets.

16. The computer-implemented method of claim 11 further comprising monitoring one or more inference power traces of the one or more chiplets for one or more characteristics that are abnormal or consistent with one or more malicious attacks.

17. The computer-implemented method of claim 11 further comprising:
generating a quantization configuration based on one or more model parameters of the machine learning model;
generating a high-level synthesis model based on the machine learning model and the quantization configuration; and
generating a register-transfer level model based on the high-level synthesis model.

18. The computer-implemented method of claim 11, wherein generating the one or more power anomaly predictions comprises determining one or more of (i) deviations from normal behavior, (ii) similarities to malicious attacks, or (iii) deviations between expected behaviors and actual behaviors.

19. The computer-implemented method of claim 11 further comprising determining one or more malicious activities based on the one or more power anomaly predictions.

20. The computer-implemented method of claim 19 further comprising initiating the performance of one or more prediction-based actions based on the determination of the one or more malicious activities.
